(19) United States
(12) Patent Application Publication
(10) Pub. No.: US 2019/0310343 A1
(43) Pub. Date: Oct. 10, 2019

(54) PROCESSING APPARATUS, COMPUTER PROGRAM CODE, AND METHOD

(71) Applicant: INDOORATLAS OY, Oulu (FI)

(72) Inventors: Arno SOLIN, Helsinki (FI); Juha ALA-LUHTALA, Helsinki (FI); Otto SEISKARI, Helsinki (FI); Simo SÄRKKÄ, Vantaa (FI); Kimmo SÄÄSKILAHTI, Helsinki (FI)

(73) Assignee: INDOORATLAS OY, Oulu (FI)

(21) Appl. No.: 16/340,199

(22) PCT Filed: Oct. 6, 2016
(86) PCT No.: PCT/FI2016/050696

§ 371 Date: Apr. 8, 2019

(51) Int. Cl. G01S 5/02; G01B 21/00

(52) U.S. Cl. CPC G01S 5/0294; G01B 21/00; G01S 5/0268

(57) ABSTRACT

A method in a processing apparatus includes: obtaining measurement data generated by one or more information sources; selecting one or more parts of a map; and processing the measurement data with a state estimation algorithm within the confines of the selected one or more parts in order to determine an estimated state of a mobile apparatus.

### FIELD

The invention relates to a processing apparatus, computer program code for the processing apparatus, and a method in the processing apparatus.

### BACKGROUND

The location services are booming. Consequently, it is desirable to refine techniques for determining an estimated location.

### BRIEF DESCRIPTION

The present invention seeks to provide an improved processing apparatus, improved computer program code for the processing apparatus, and an improved method in the processing apparatus.

According to an aspect of the present invention, there is provided a processing apparatus as specified in claim 1.

According to another aspect of the present invention, there is provided computer program code stored in a non-transitory computer-readable storage medium as specified in claim 30.

According to another aspect of the present invention, there is provided a method in a processing apparatus as specified in claim 31.

### LIST OF DRAWINGS

Example embodiments of the present invention are described below, by way of example only, with reference to the accompanying drawings, in which

FIGS. 1, 2 and 3 illustrate example embodiments of a processing apparatus;

FIG. 4 illustrates a user walking a spatial path;

FIG. 5 illustrates an example embodiment of a user interface of a mobile apparatus;

FIGS. 6, 7, 8, 9 and 10 illustrate example embodiments of a map;

FIGS. 11, 12A, 12B, 13, 14, 15, 16, 17, 18, 19A and 19B illustrate example embodiments of parts of a map;

FIG. 20 illustrates further the user walking the spatial path; and

FIG. 21 illustrates further the user interface of the mobile apparatus.

### DESCRIPTION OF EMBODIMENTS

The following embodiments are only examples. Although the specification may refer to “an” embodiment in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

It should be noted that while Figures illustrate various embodiments of apparatuses, they are simplified block diagrams that only show some structures and functional entities. The connections shown in these Figures are logical connections; the actual physical connections may be different. Interfaces between the various elements may be implemented with suitable interface technologies, such as a message interface, a method interface, a sub-routine call interface, a block interface, or any hardware/software means enabling communication between functional sub-units. It is apparent to a person skilled in the art that the described apparatuses may also comprise other functions and structures. It should be appreciated that details of some functions, structures, and the protocols used for communication are irrelevant to the actual invention. Therefore, they need not be discussed in more detail here.

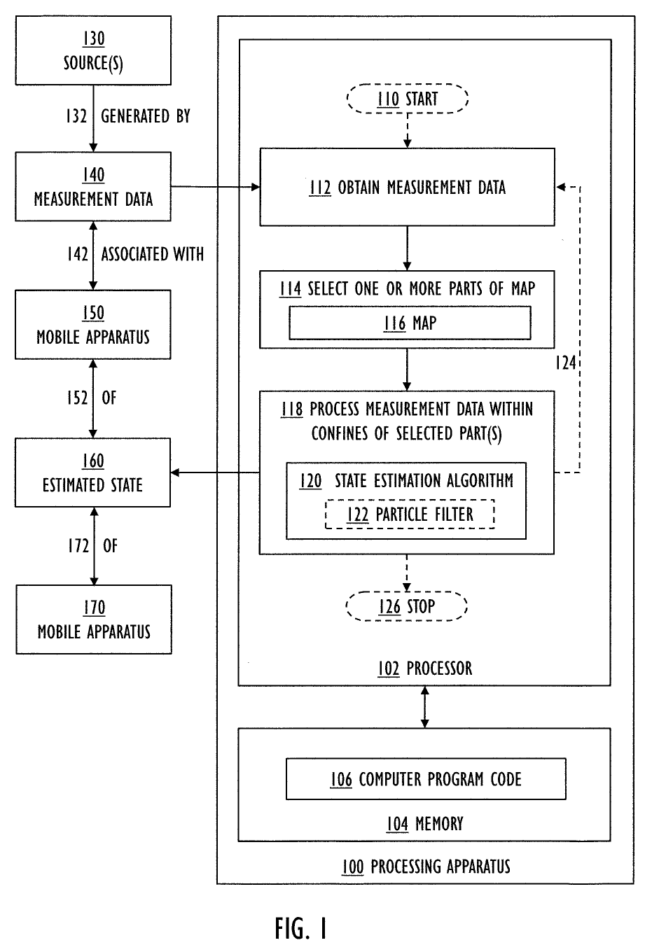

FIG. 1 illustrates example embodiments of a processing apparatus 100.

The processing apparatus 100 comprises one or more processors 102, and one or more memories 104 including computer program code 106.

The term ‘processor’ 102 refers to a device that is capable of processing data. Depending on the processing power needed, the processing apparatus 100 may comprise several processors 102 such as parallel processors or a multicore processor. When designing the implementation of the processor 102, a person skilled in the art will consider the requirements set for the size and power consumption of the processing apparatus 100, the necessary processing capacity, production costs, and production volumes, for example. The processor 102 and the memory 104 may be implemented by an electronic circuitry.

The term ‘memory’ 104 refers to a device that is capable of storing data run-time (=working memory) or permanently (=non-volatile memory). The working memory and the non-volatile memory may be implemented by a random-access memory (RAM), dynamic RAM (DRAM), static RAM (SRAM), a flash memory, a solid state disk (SSD), PROM (programmable read-only memory), a suitable semiconductor, or any other means of implementing an electrical computer memory.

The computer program code 106 may be implemented by software and/or hardware. In an example embodiment, the software may be written by a suitable programming language, and the resulting executable code 106 may be stored on the memory 104 and run by the processor 102. In an alternative example embodiment, the functionality of the hardware may be designed by a suitable hardware description language (such as Verilog or VHDL), and transformed into a gate-level netlist (describing standard cells and the electrical connections between them), and after further phases the chip implementing the processor 102, memory 104 and the code 106 of the processing apparatus 100 may be fabricated with photo masks describing the circuitry.

The one or more memories 104 and the computer program code 106 are configured to, with the one or more processors 102, cause the processing apparatus 100 at least to perform the following three operations:

112) obtain measurement data 140 generated 132 by one or more information sources 130.

114) select one or more parts of a map 116.

118) process the measurement data 140 with a state estimation algorithm 120 within the confines of the selected one or more parts in order to determine an estimated state 160 of 152 a mobile apparatus 150, 170.

In an example embodiment, the measurement data 140 is associated 142 with a mobile apparatus 150.

In an example embodiment, the estimated state 160 is for 152 the mobile apparatus 150 that is associated 142 with the measurement data 140. In an example embodiment, the estimated state 160 is for 172 the mobile apparatus 170 that is not (directly) associated with the measurement data 140. Such collaborative processing is based on a fact that the mobile apparatuses 150/170 are somehow associated with each other: they are within a short radio range of each other, or the processing apparatus 100 in some other way knows that the measurement data 140 directly associated 142 with the first mobile apparatus 150 is also relevant for the second mobile apparatus 170.

In the following, for ease of reference, the mobile apparatus is referred to with reference numeral 150, but also in those case the mobile apparatus may as well be the mobile apparatus 170.

In an example embodiment, the estimated state 170 of the mobile apparatus 150 comprises one or more of the following: a location of the mobile apparatus 150, a speed of the mobile apparatus 150, a heading of the mobile apparatus 150, an alignment of the mobile apparatus 150.

With this sequence, it is possible to determine the estimated location 160 without any initial position, as the state estimation algorithm 120 is used to define the estimated location within the confines of the selected one or more parts of the map 116. The map 116 may be a continuous global map, and the selected one or more parts of the map 116 reflect an initial, rough idea of the whereabouts of the mobile apparatus 150. But, as was said, no initial position is needed, and the state estimation algorithm 120 operates over the whole area covered by the selected parts of the map 116. Furthermore, the map 116 processing becomes dynamic with the use of the state estimation algorithm 120: the whole map 116 may initially be used, or, if there is even a faint idea of the location, parts of the map 116 may be selected, which may save processing resources (processor, memory, telecommunications). The state estimation algorithm 120 does not “see” the parts of the map 116 as it operates with the given parts.

In an example embodiment, the state estimation algorithm 120 comprises a particle filter based algorithm 122. Technical details of the particle filter 122 are not presented here in great detail, instead, the reader is advised to consult the following references incorporated herein by reference: a report by Fredrik Gustafsson in year 2010: “Particle Filter Theory and Practice with Positioning Applications”, IEEE Aerospace and electronic system magazine, (25) 7: 58-81, and a book by Simo Särkkä in year 2013: “Bayesian Filtering and Smoothing”, Cambridge University Press.

In an example embodiment, the particle filter based algorithm 122 functions as follows:

The measurement data 140 and the map 116 are known, but the estimated location 160 on the map 116 is not known. The measurement data 140 relates to the estimated location 160. The relationship between the measurement data 140 and the estimated location 160 is known. With the particle filter 122, the estimated location 160 may be determined based on the measurement data 140.

First, location hypotheses, i.e., particles, are generated. This may be done from a random distribution, for example.

Next, likelihood of each particle is evaluated in view of the measurement data 140. Based on the likelihood, a weight is given to the particle. Some particles appear more likely than other particles.

Then, resampling is performed: new particles are generated, not randomly as in the beginning, but based on the existing particles with their weights. The resampling avoids depletion among the particles. As all particles are re-generated, they all will be given equal weights.

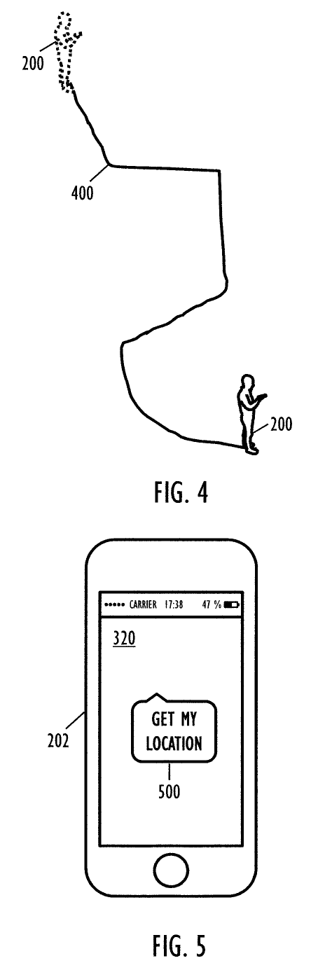

As the user 200 moves on the spatial path 400 (see FIG. 4), the particles need to be moved as well with some model. In an example embodiment, the direction and speed of the user's movement may be directed with dead reckoning as the model. For each particle, a random number may be picked within the likely range of the speed, and then each particle is moved with the corresponding speed (on the spatial path 400, for example). In this way, the particles are propagated in time.

Then, the weights are updated using the new measurement data 140. Basically, the above mentioned evaluation, resampling and moving of the particles is repeated for a needed number of cycles so that a reliable estimated location 160 is obtained.

Note that this example sequence of the particle filter based algorithm 122 may be modified, without affecting the core of the described operation sequence 112-114-118.

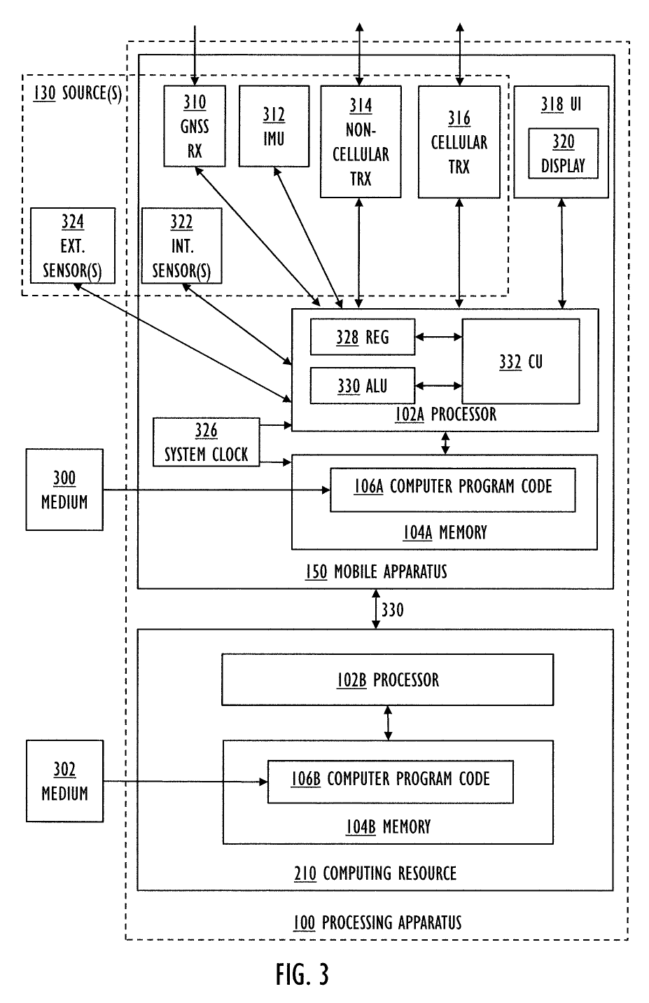

Dead reckoning refers to navigation in which a current position of the mobile apparatus 150 is calculated by using a previously determined position, fix, and advancing that position based on a determined speed over elapsed time and course. The speed and the course may be determined with various ways, such as by inertial measurement data (such as acceleration data and/or gyroscope data) produced by an inertial measurement unit 312 (see FIG. 3). If the mobile apparatus 150 is carried around by a pedestrian, pedestrian dead reckoning (PDR) may be used for the construction of the spatial path 400, with all of its finesses (such as the use of step detection, cadence, and direction, all of which may be detected with a pedometer or an acceleration sensor, for example). Also other measurements may be utilized (such as speedometer, milometer and steering direction data provided that the mobile apparatus 150 is coupled with a vehicle). The spatial path 400 may be the determined course or a plurality of determined successive positions. Positions may also be determined with other types of sensor data, with magnetic field data, with radio frequency based positioning utilizing transceivers 314/316 and the so-called triangulation (with reception power information of two or more base stations, for example), for example, and other ways of recognizing a position from among known positions (such as camera-based positioning, for example). The location may be determined with an accuracy that may vary: the known location may be very accurate, within an error margin of a few meters, or less accurate, such as being specific to a certain area (possibly having some radius like 100 meters or less or more, for example).

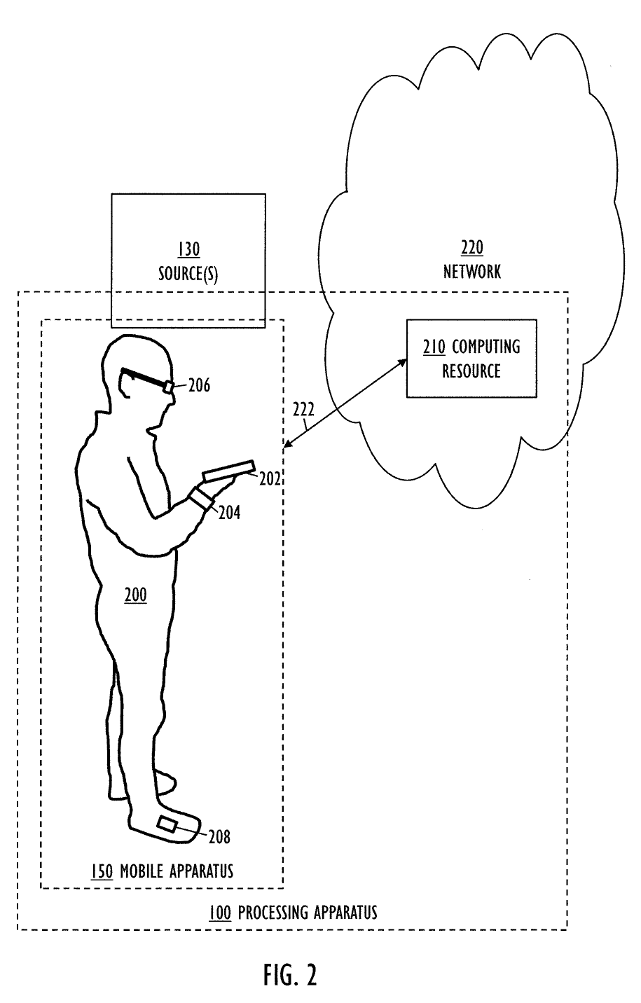

In an example embodiment, illustrated in FIG. 2, the processing apparatus 100 comprises a mobile apparatus 150 manipulated by a user 200, and/or a computing resource 210.

In an example embodiment, the mobile apparatus 150 and the computing resource 210 are communicatively couplable 222 with each other. This means that the functionality of the processing apparatus 100 may be centralized in one apparatus, such as in the mobile apparatus 150 or in the computing resource 210, or distributed between a plurality of intercommunicating apparatuses 150, 210.

In an example embodiment, the mobile apparatus 150 is a portable electronic communication apparatus. A non-exhaustive list of the types of the mobile apparatus 150 includes: a mobile phone 202, a smartphone 202, a tablet computer 202, a phablet 202, a smartwatch 204, smartglasses 206, a footpod 208, a general-purpose mobile computing device. In an example embodiment, the mobile apparatus 150 is a general-purpose off-the-shelf computing device, as opposed to a purpose-build proprietary equipment, whereby research & development costs will be lower as only the special-purpose software (and not the hardware) needs to be designed, implemented and tested.

In FIG. 5, an example embodiment of the mobile apparatus 150 is illustrated: a smartphone 202 employing a display 320. The mobile apparatus 150 may employ a suitable operating system such as iOS, Android, or Windows Phone, for example.

Also such example embodiment is feasible, wherein the mobile apparatus 150 is a part of or is fixed to another type of apparatus capable of moving around, such as a trolley, a mining vehicle, a robot, an automated guided vehicle, a submersible etc.

In an example embodiment, the computing resource 210 may be implemented as a single server computer or as a cluster of computers. The server is a part of the client-server computing model that acts as distributed application which partitions tasks or workloads between the provider of a resource or service, called server, and the service requester, called client. The server 210 may serve a number of mobile apparatuses 150. The server computer 210 may be a host that is running one or more server programs which share their resources with clients 150. The client 150 may request a service function relating to the magnetic positioning from the server 210. Also, the client 150 may initiate a communication session with the server 210 which awaits incoming requests.

In an example embodiment, the computing resource 210 may also operate according to the cloud computing model, at least in part. Naturally, besides these example embodiments of the computing resource 210, other feasible computing architectures may be utilized as well to implement the hardware and software of the computing resource 210. Consequently, besides operating according to the client/server architecture, push technology may be utilized as well. In push technology, the request for a transaction is initiated by the computing resource 210, whereas with the pull technology the request for the information is initiated by the client 150.

In an example embodiment, illustrated in FIG. 2, the computing resource 210 may be accessible through a communication network 220. In an example embodiment, the communication network 220 comprises at least one of a wireless local area network base station, an indoor base station, an access point, a wireless hot-spot, all of which may provide Internet access of the computing resource 210 through the use of a router connected to a link to an Internet service provider. In an example embodiment, the communication network 220 comprises a wireless standard/non-standard/proprietary cellular communication network such as any mobile phone network. In an example embodiment, the communication network 220 comprises a wired standard/non-standard/proprietary connection (such as Ethernet or USB), whereby the mobile apparatus 150 may sporadically, be coupled in a wired fashion with the communication network 220, and possibly also with the computing resource 210.

In an example embodiment, the wireless communication network 220 comprises any mobile phone network, regardless of the generation (such as 2G, 3G, 4G, beyond 4G, 5G etc.) such as GSM (Global System for Mobile Communications), GPRS (General Packet Radio Service), EGPRS (Enhanced GPRS), WCDMA (Wideband Code Division Multiple Access), UMTS (Universal Mobile Telephone System), 3GPP (The 3rd Generation Partnership Project), IMT (International Mobile Telecommunication), LTE (Long Term Evolution, LTE-A (LTE-Advanced), Mobile WiMAX, and other radio systems (in their present forms and/or in their evolution forms).

In an example embodiment, the communication network 220 supports the use of subscriber identity module (SIM), which may be an integrated circuit storing subscriber data, which is network-specific information used to authenticate and identify the subscriber on the cellular network. The subscriber+identity module may be embedded into a removable SIM card. Consequently, the mobile apparatus 150 may include the SIM card (and a SIM card reader). Alternatively, the mobile apparatus 150 may include a virtual or software SIM card.

In essence, FIG. 2 illustrates an example embodiment, wherein the functionality of the processing apparatus 100 may be implemented in a centralized fashion, even in a single apparatus 150/210, or in a distributed fashion, even in a number of communicatively couplable separate apparatuses 150, 210, 202, 204, 206, 208.

FIG. 3 illustrates an example embodiment, wherein the processing apparatus 100 comprises the mobile apparatus 150 and the computing resource 210. Both apparatuses 150, 210 comprise one or more processors 102A, 102B, one or more memories 104A, 104B, and the (distributed) computer program code 106A, 106B.

In an example embodiment, the mobile apparatus 150 comprises a display 320. In an example embodiment, the display 320 is implemented by an appropriate technology, such as a liquid crystal display (LCD), a thin-film transistor (TFT) display, a light-emitting diode (LED) display, an organic LED (OLED) display, an electroluminescent display (ELD), or an electronic paper (or e-paper or electronic ink) display, for example. The display 320 may also incorporate other user interaction means, such as touch input, or haptic feedback, i.e. the display may be a multi-touch display 320.

In an example embodiment, the display 320 may be a part of the user interface 318 implementing the exchange of graphical, textual and/or auditory information with the user 200. The user interface 318 may be realized with various techniques, such as the display 320, means for producing sound, a keyboard, and/or a keypad, for example. The means for producing sound may be a loudspeaker or a simpler means for producing beeps or other sound signals. The keyboard/keypad may comprise a complete (QWERTY) keyboard, a mere numeric keypad or only a few push buttons and/or rotary buttons. In addition, or alternatively, the user interface 318 may comprise other user interface components, for example various means for focusing a cursor (mouse, track ball, arrow keys, touch sensitive area etc.) or elements enabling audio control.

In an example embodiment, the mobile apparatus 150 comprises a GNSS (Global Navigation Satellite System) receiver 310, which generates the measurement data 140 on the basis of signals received from Earth-orbiting satellites. The GNSS may be GPS (Global Positioning System) of the USA, Galileo of the European Union, GLONASS of Russia, Beidou of China, or IRNSS of India, for example. Besides GNSS, or instead of GNSS, other location techniques may be utilized as well such as those developed for use in cellular radio networks, and, consequently, the location data may be obtained from the cellular radio network.

In an example embodiment, the mobile apparatus 150 comprises an inertial measurement unit 312, which generates the measurement data 140. The inertial measurement unit 312 may comprise a magnetometer to measure variations in the magnetic field caused by building structures (especially by steel frames and steel-reinforced concrete). Furthermore, the inertial measurement unit 312 may comprise an acceleration sensor (measuring in one, two or three dimensions) and/or a gyroscope, for example. It is to be noted that the inertial measurement unit 312 and software 106A may co-operate with the computing resource 210 in order to implement the positioning.

In an example embodiment, the mobile apparatus 150 comprises a cellular radio transceiver 316 and/or a non-cellular radio transceiver 314. The measurement data 140 may be obtained/generated on the basis of the wireless communication utilizing the transceivers 314 and/or 316.

In an example embodiment, the cellular radio transceiver 316 may be interoperable with the already-mentioned various wireless standard/non-standard/proprietary cellular communication network 220.

In an example embodiment, the non-cellular radio transceiver 314 may utilize a short-range radio transceiver such as a Bluetooth, Bluetooth low energy (BLE), Wi-Fi (or WiFi) or other WLAN (Wireless Local Area Network) transceiver (based on IEEE (Institute of Electrical and Electronics Engineers) 802.11 standard or its evolution versions (IEEE 802.11ac etc.), for example).

The measurement data 140 may also be obtained with some other means. In an example embodiment, the mobile apparatus 150 may comprise a short range wireless reader configured to read the measurement data 140 from a tag attached fixedly to a known location. The short range wireless radio reader may operate utilizing electric and/or magnetic fields, such as radio frequency identification (RFID) or near-field communication (NFC), for example In an example embodiment, the mobile apparatus 150 comprises a camera, and the measurement data 140 may be obtained by photographing a machine readable code (such as a barcode or a QR code) attached fixedly to a known location or by photographing or recording video (from a floor, walls and/or ceiling) and identifying the location from identified unique features. In an example embodiment, the mobile apparatus 150 comprises a depth camera (possibly with infrared technology) as the information source, and the resulting three-dimensional images may be utilized in the location determination.

In an example embodiment, a system clock 326 constantly generates a stream of electrical pulses, which cause the various transferring operations within the mobile apparatus 150 to take place in an orderly manner and with specific timing. The system clock 326 may be utilized to provide timing data for the measurement data 140.

Naturally, the mobile apparatus 150 may include various other parts, such as a battery, a camera, or a radio-frequency identifier reader etc. Similarly, the computing resource 210 may comprise other parts and functionalities.

In an example embodiment, the one or more information sources 130 comprise sensors, which are communicatively coupled with the mobile apparatus 150. As shown in FIG. 3, the information source(s) 130 may comprise internal sensors 322, external sensors 324, and the already mentioned GNSS receiver 310, inertial measurement unit 312, non-cellular transceiver 314, and cellular transceiver 316 may also be regarded as the information sources 130 in that sense that they may generate different types of the measurement data 140.

In an example embodiment, the measurement data 140 comprises at least one of the following types of the measurement data: inertial sensor data, magnetometer data, indoor base station data, cellular network data, wireless access point data, WiFi data, Bluetooth radio data, air pressure data, illumination data, audio data, video data, camera data, temperature data, barometer data, altitude data, range sensor data, indoor positioning data, global navigation satellite system data, smell sensor data, air quality sensor data, radar data, data generated by the internal sensor 322 of the mobile apparatus 150, data generated by the sensor 324 external to the mobile apparatus 150.

In an example embodiment, the processor 102A (and also 102B) may be implemented as a microprocessor implementing functions of a central processing unit (CPU) on an integrated circuit. The CPU is a logic machine executing the computer program code 106A. The computer program code 106A may be coded as a computer program using a programming language, which may be a high-level programming language, such as C, C++, or Java, or a low-level programming language, such as a machine language, or an assembler, for example. The CPU may comprise a set of registers 328, an arithmetic logic unit (ALU) 330, and a control unit (CU) 332. The control unit 332 is controlled by a sequence of the computer program code 106A transferred to the CPU from the (working) memory 104A. The control unit 332 may contain a number of microinstructions for basic operations. The implementation of the microinstructions may vary, depending on the CPU design. The microprocessor 102A may also have an operating system (a dedicated operating system of an embedded system, a real-time operating system, or even a general-purpose operating system), which may provide the computer program code 106A with system services.

A non-exhaustive list of implementation techniques for the processor 102A and the memory 104A includes, but is not limited to: logic components, standard integrated circuits, application-specific integrated circuits (ASIC), system-on-a-chip (SoC), application-specific standard products (ASSP), microprocessors, microcontrollers, digital signal processors, special-purpose computer chips, field-programmable gate arrays (FPGA), and other suitable electronics structures.

In an example embodiment, the processor 102A and the memory 104A are separate entities, communicatively coupled together by an appropriate serial bus, for example. In general interfaces between the various elements may be implemented with suitable interface technologies, such as a message interface, a method interface, a sub-routine call interface, a block interface, an appropriate serial/parallel bus, or any hardware/software means enabling communication between various sub-units of the mobile apparatus 150.

An example embodiment provides a computer-readable medium 300, 302 comprising the computer program code 106A, 106B which, when loaded into the processing apparatus 100 and executed by the processing apparatus 100 causes the processing apparatus 100 to implement the described example embodiments.

The example embodiments of the processing apparatus 100 may be used to enhance the operation of the computer program code 106. There are many ways to structure the computer program code 106. In an example embodiment, the operations of the computer program code 106 may be divided into functional modules, sub-routines, methods, classes, objects, applets, macros, etc., depending on the software design methodology and the programming language used. In modern programming environments, there are software libraries, i.e. compilations of ready-made functions, which may be utilized by the computer program code 106 for performing a wide variety of standard operations. In an example embodiment, the computer program code 106 may be in source code form, object code form, executable file, or in some intermediate form. The computer-readable medium 300, 302 may comprise at least the following: any entity or device capable of carrying computer program code 106 to the processing apparatus 100, a record medium, a computer memory, a read-only memory, an electrical carrier signal, a telecommunications signal, and a software distribution medium. In some jurisdictions, depending on the legislation and the patent practice, the computer-readable medium 300, 302 may not be the telecommunications signal. In an example embodiment, the computer-readable medium 300, 302 may be a non-transitory computer-readable storage medium.

Now that we have described the general operation environment with reference to FIGS. 1, 2 and 3, let us explain more example embodiments relating to the actual determination of the estimated location 160.

In FIG. 4, a user 200 of the mobile apparatus 150 walks a spatial path 400.

In FIG. 5, the user 200 starts a location application 500 by tapping the screen 320 of the mobile phone 202.

In an example embodiment, the one or more parts of the map 116 are selected based on a history of one or more previous events associated with the mobile apparatus 150. In an example embodiment, it may be checked whether the user 200 is visiting the same place as a family member, a colleague, or some other person associated with the user 200 has previously visited.

In an example embodiment, the one or more parts of the map 116 are selected based on a history of one or more past locations of the mobile apparatus 150. As the user 200 is likely to visit certain places repeatedly, it may be logical to check these first.

In an example embodiment, the one or more parts of the map 116 are selected based on network data associated with the mobile apparatus 150. This means that the previously explained communication network 220 may be aware of the approximate location of the mobile apparatus 150: the network 220 may be aware of the country code of the currently served subscriber terminal 150, for example,

In an example embodiment, the one or more parts of the map 116 are selected based on surveillance data associated with the mobile apparatus 150. For example, surveillance cameras may spot and recognize the user 200 (in an airport, in a mall, or in a street, for example).

In an example embodiment, the one or more parts of the map 116 are selected based on the measurement data 140.

In an example embodiment, illustrated in FIG. 6, the map 116 is a global map 600. The “global” may mean that the map 116 is truly global, comprising all possible locations in the globe 600 within the scope of the processing apparatus 100. Alternatively, the map 116 may be global within some constraints: for example, the map 116 may be global in the sense that it covers all retails stores of a company world-wide.

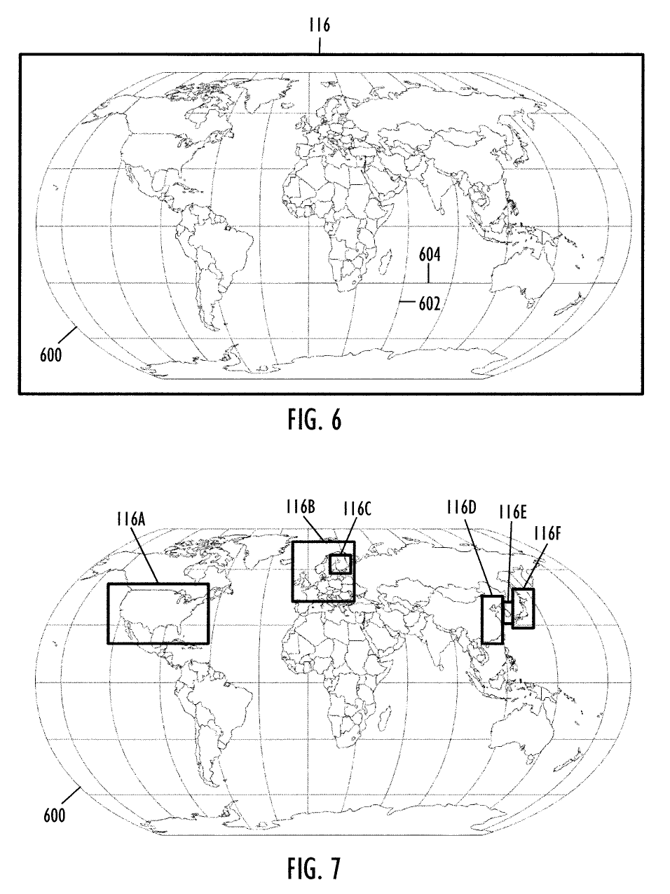

FIG. 7 illustrates another kind of global map 116, comprising those parts of the globe 600 where the location 160 may be estimated: in our example the map 116 may comprise a map 116A of the North America, a map 116B of the Europe, a map 116D of the part of China, a map 116E of South Korea, and a map 116F of Japan. Note that the parts of the map 116 may be overlapping: within the map 116C of the Europe there is a map 116C of Finland and its near regions.

FIG. 8 illustrates the map 116C of Finland in detail.

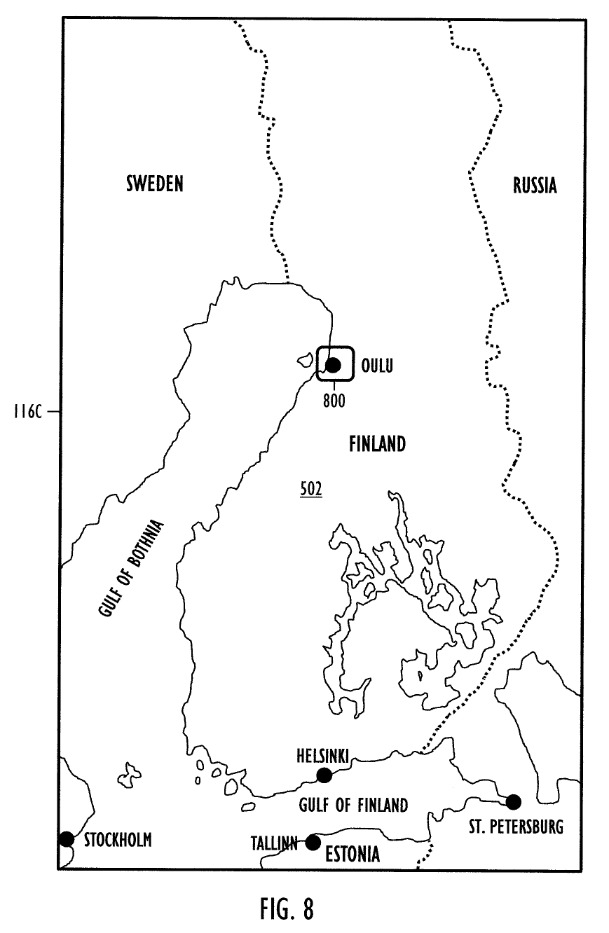

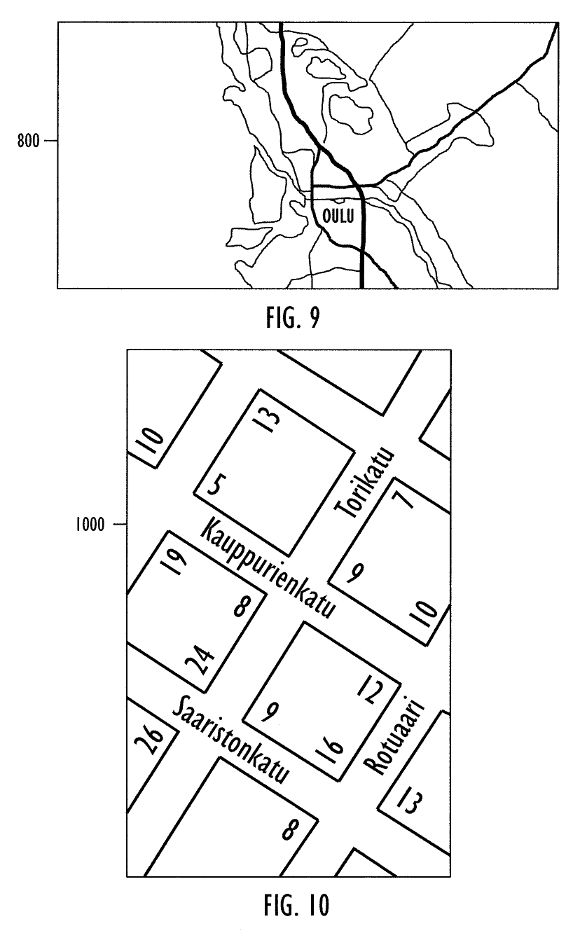

FIG. 9 illustrates a map 800 of Oulu in detail.

FIG. 10 illustrates a map 1000 of the city center of Oulu with a granularity of street level.

FIGS. 11, 12A, 12B, 13, 14, 15, 16, 17, 18, 19A and 19B illustrate example embodiments of parts of the map 116.

In an example embodiment illustrated in FIG. 11, the map 116 is divided into the parts 1100A, 1100B, 1100C, 1100D so that the parts 1100A, 1100B, 1100C, 1100D are side by side adjacent.

In an example embodiment illustrated in FIGS. 12A and 12B, the map 116 is divided into the parts 1100A, 1100B so that the parts 1100A, 1100B are at least partly overlapping. Note that also such an example embodiment is feasible wherein the map parts overlap as each part is for a different floor of a building. In this sense, the map may also be wholly three-dimensional (instead of being just two-dimensional).

In an example embodiment illustrated in FIG. 11, the map 116 is divided into the parts 1100A, 1100B, 1100C, 1100D so that the parts 1100A, 1100B, 1100C, 1100D are of a regular shape.

In an example embodiment illustrated in FIG. 11, the map 116 is divided into the parts 1100A, 1100B, 1100C, 1100D so that the parts 1100A, 1100B, 1100C, 1100D are of a polygon shape. The polygon may be bounded by four line segments closing in a loop as illustrated, or there may be another number of line segments.

In an example embodiment illustrated in FIG. 11, the map 116 is divided into the parts 1100A, 1100B, 1100C, 1100D so that the parts 1100A, 1100B, 1100C, 1100D are of a square shape.

In an example embodiment illustrated in FIG. 6, the map 116 is divided into the parts so that the parts are such that their sides are defined geographically along the longitudes 602 and the latitudes 604 of the Earth 600.

In an example embodiment, the parts 1100A, 1100B, 1100C, 1100D of the map 116 are formed as tiles.

In an example embodiment, the parts 1100A, 1100B, 1100C, 1100D of the map 116 may be of various sizes, such as from square meters to square kilometers, and even larger.

In an example embodiment, the map 116 is divided into the parts so that a size of the part and/or a location of the part is selected dynamically. In an example embodiment, the dynamic selection is performed before processing the measurement data 140 with the state estimation algorithm 120.

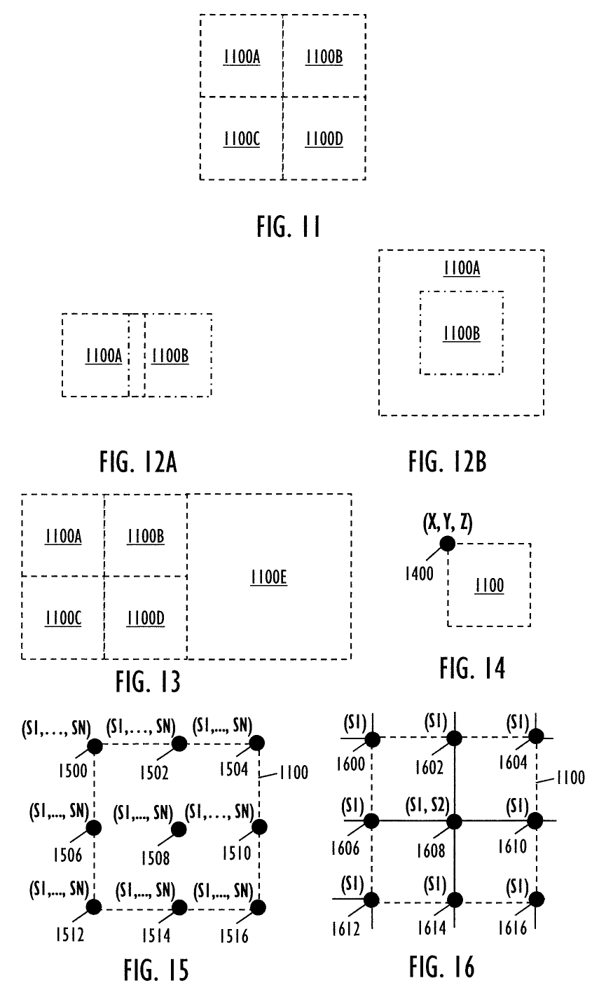

In an example embodiment illustrated in FIG. 13, the map 116 is divided into the parts 1100A, 1100B, 1100C, 1100D, 1100E so that the map 116 comprises parts 1100A, 1100B, 1100C, 1100D, 1100E of different size.

In an example embodiment illustrated in FIG. 14, the map 116 is fixed to a co-ordinate system. For example, a corner (or other predetermined position) of a part 1100 is fixed to a co-ordinate (which may determine the location in three dimensions, x, y and z) 1400.

In an example embodiment, the map 116 covers indoor locations comprising buildings, subways, train stations, airports, harbors, mines and other man-made structures above ground or underground, and possibly also outdoor locations adjacent to the indoor locations.

In an example embodiment illustrated in FIG. 15, the map 116 comprises a plurality of locations 1500, 1502, 1504, 1506, 1508, 1510, 1512, 1514, 1516, and each location 1500, 1502, 1504, 1506, 1508, 1510, 1512, 1514, 1516 is associated with one or more previously measured and stored values (S1, . . . , SN), which are comparable with the measurement data 140.

In an example embodiment, the locations 1500, 1502, 1504, 1506, 1508, 1510, 1512, 1514, 1516 are geographical locations.

In an example embodiment, the locations 1500, 1502, 1504, 1506, 1508, 1510, 1512, 1514, 1516 are not absolute locations as the geographical locations are but tied to some relative reference, such as being locations within a building, a vessel (such as a ship) etc.

Note that the values (S1, . . . , SN) may be measured at the specific location 1500, 1502, 1504, 1506, 1508, 1510, 1512, 1514, 1516, or they may be generated from adjacent location(s), by an interpolation, for example.

In an example embodiment, stored values may comprise magnetic vector strength and direction in several locations within a building or within a plurality of buildings. The stored values may thus form an indoor magnetic field map. As implied by the word “map”, the magnetic field map comprises location specific data: each location in the map is associated with a certain magnetic field value (magnitude and/or direction), for example. Additionally, or instead of, the stored values may form a radio frequency map indicating received radio signal (transmitted from different WiFi access points) strengths, possibly with base station identifiers, in various locations.

In an example embodiment illustrated in FIG. 16, a grid of the values is specific to a type of the information source, which results in that a part of the map 1100 comprises the values in different grids of different information source: sensor 1 values S1 are for each geographical position 1600, 1602, 1604, 1606, 1608, 1610, 1612, 1614, 1616, which means that the grid has three horizontal lines and three vertical lines for the part 1100, whereas sensor 2 value S2 is only for the central geographical position 1608 of the part 1100. “Different grids” may thus refer to a different spacing of the intersecting lines (which may be straight/curved and vertical/horizontal/angular).

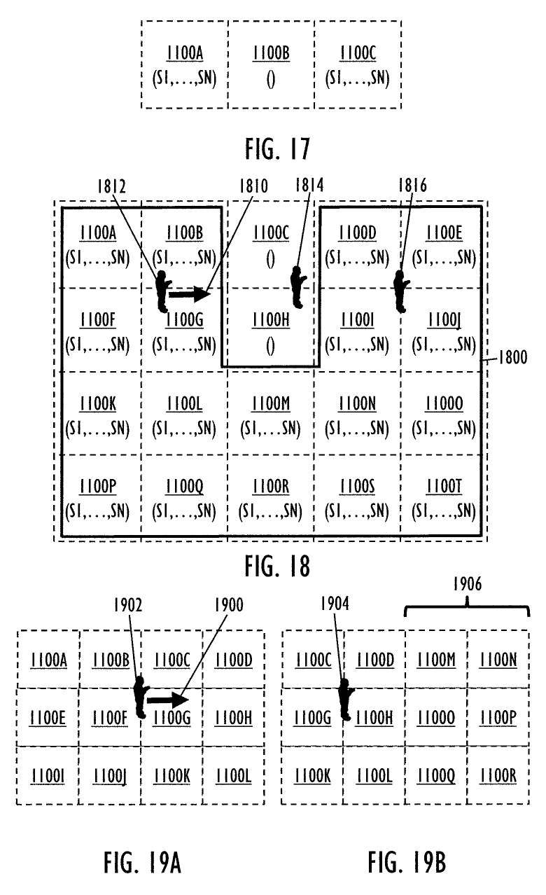

In an example embodiment illustrated in FIG. 17, a part 1100B of the map 116 is empty. “Empty” means that it has no previously measured and stored values, which are comparable with the measurement data 140.

In an example embodiment illustrated also in FIG. 17, the empty part 1100B connects two non-empty parts 1100A, 1100C of the map 116.

In an example embodiment illustrated in FIG. 18, the empty part 1100C, 1100H is located at least partly outdoors and it connects two non-empty parts, 1100B and 1100D, and 1100G and 1100I, which are located at least partly indoors 1800. In the example embodiment of FIG. 18, indoors is inside a building 1800.

In an example embodiment illustrated also in FIG. 18, the measurement data 140 is processed with the state estimation algorithm 120 utilizing the particle filter 122, wherein weights of the particle filter 122 are modified at least partly based on one or more of the following: an uncertainty of the map 116 related to a specific particle, an empty part of the map 116 related to a specific particle. For example: if a detected movement direction 1810 of the mobile apparatus 150 is from the non-empty part 1100G towards the empty part 1100H, it is taken into account that the mobile apparatus 150 advances into the empty part 1100H. In the example embodiment of FIG. 18, the user 200 advances into the direction 1810 from the position 1812, arriving at positions 1814 and 1816.

In an example embodiment illustrated in FIGS. 19A and 19B, the selection of the one or more parts of the map 116 is performed anew so that new parts 1906 of the map 116 are selected based on a prediction of a future state 1900 of the mobile apparatus 150, which is based on the estimated state of the mobile apparatus 150. The mobile apparatus 150 moves from a location 1902 to a location 1904. In the example embodiment of FIG. 19A, the selected map parts are 1100A, 1100B, 1100C, 1100D, 1100E, 1100F, 1100G, 1100H, 1100I, 1100J, 1100K and 1100L. Based on the predicted future movement 1900, some map parts are discarded and new map parts selected, so that in FIG. 19B the selected map parts are 1100C, 1100D, 1100G, 1100H, 1100K, 1100L, all of which were also selected in FIG. 19A, and, additionally, new selected map parts 1906 are 1100M, 1100N, 1100O, 1100P, 1100Q, 1100R. In an example embodiment, the measurement data 140 is processed with the state estimation algorithm 120 utilizing the particle filter 122 so that it comprises updating weights using the measurement data 140, and resampling with respect to the weights and propagating the particles in time using a model, wherein the map re-selection is performed as described above.

In an example embodiment, the measurement data 140 is processed with the state estimation algorithm 120 utilizing the particle filter 122, and wherein a first round of the processing with the particle filter is performed with one or more types of the measurement data 140, and a second and subsequent rounds of the processing with the particle filter are performed with more types of the measurement data 140 and/or with different types of the measurement data 140 than in the previous round (such as in the first round). In an example embodiment, the above described processing also comprises updating weights using the measurement data 140, resampling with respect to the weights and propagating the particles in time using a model.

Let us now return back to FIGS. 4 and 5: in FIG. 4, the user 200 walks the spatial path 400, and in FIG. 5, the user 200 starts the location application 500 in the mobile phone 202.

As shown in FIG. 20, the spatial path is mapped onto a map 2000 of a building, and also the map parts 1100A, 1100B etc. are shown.

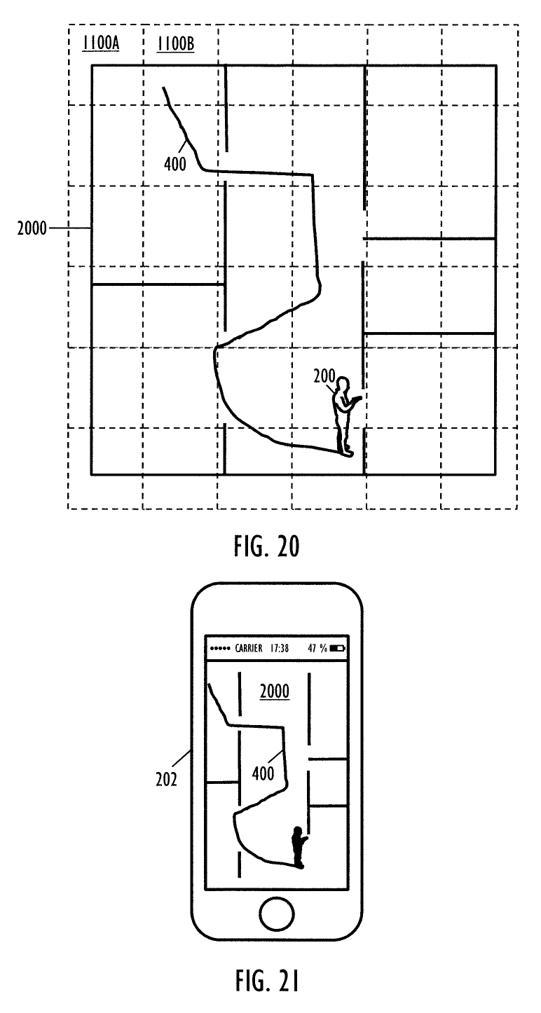

In FIG. 21, the map 2000 and the route 400 of the user are shown in the mobile phone 202.

The Applicant, IndoorAtlas, has developed many improvements for the magnetic positioning utilizing the measurements of magnetic field, disclosed in its various patents/applications, incorporated herein by reference: U.S. Pat. Nos. 8,798,924, 9,078,104, 9,080,874, 9,151,621, 9,154,914, 9,253,601, 9,316,501, Ser. Nos. 13/871,612, 13/905,655, 13/915,016, 14/054,264, 14/093,250, 14/207,916, 14/524,420, 14/626,217, 14/725,452, 14/725,521, 14/837,678, 14/853,576, 14/859,985, 14/996,864, 14/978,148 and 15/074,085.

Steel structures (such as steel-frames or steel-reinforced concrete, for example) cause magnetic interferences indoors such as in buildings 1800, 200 mines, subways, train stations, airports, harbors, particle accelerators, and other structures above ground or underground. The disturbances inside are consistent, creating a magnetic fingerprint unique to a specific location. The measurement data 140 may thus comprise successive measurement samples of magnetic field disturbed by man-made or man-formed structures 1800, 2000 (or even natural structures such as an ore containing metal in a mine). The measured magnetic field may be the Earth's magnetic field disturbed by the various structures 1800, 2000, or even, in some cases, a powerful magnetic field created by the various structures.

In an example embodiment, magnetic positioning may be used in the described example embodiments for determining the estimated location 160. The magnetic field measurements may be a part of the measurement data 140, and made by the information sources 130 such as the inertial measurement unit 312.

In an example embodiment, the parts of the map 116 may be selected 114 based on one or more received identifiers of an access point (utilizing WiFi, for example). The identifier may be e.g. service set identifier (SSID) or a basic service set identifier (BSSID), both of which may identify the access point transmitting the RF signal, such as the WiFi signal. This may indicate the location of the access point and thereby indicate the location of the mobile apparatus 150 receiving the WiFi signal. There may be several access points in the building 1800, 2000 and it may be possible to identify the floor of the mobile apparatus 150 based on the identifier. Other ways of performing such fast global fix may be utilized as well: platform location, GNSS, WiFi, Bluetooth, or even rougher estimation methods.

Next, let us study FIG. 1 also illustrating a method performed in the processing apparatus 100. The operations are not strictly in chronological order, and some of the operations may be performed simultaneously or in an order differing from the given ones. Other functions may also be executed between the operations or within the operations and other data exchanged between the operations. Some of the operations or part of the operations may also be left out or replaced by a corresponding operation or part of the operation. It should be noted that no special order of operations is required, except where necessary due to the logical requirements for the processing order.

The method starts in 110.

In 112, measurement data generated by one or more information sources is obtained.

In 114, one or more parts of a map are selected.

In 118, the measurement data is processed with a state estimation algorithm within the confines of the selected one or more parts in order to determine an estimated state of a mobile apparatus.

The method ends in 126, or, as illustrated by the reference numeral 124, the operations may be performed recursively (in order to continuously determine the estimated location, for example).

The already described example embodiments of the processing apparatus 100 may be utilized to enhance the method with various further example embodiments. For example, various structural and/or operational details may supplement the method.

It will be obvious to a person skilled in the art that, as technology advances, the inventive concept can be implemented in various ways. The invention and its embodiments are not limited to the example embodiments described above but may vary within the scope of the claims.

1. A processing apparatus comprising:
one or more processors; and
one or more memories including computer program code,
the one or more memories and the computer program code configured to, with the one or more processors, cause the processing apparatus at least to:
obtain measurement data generated by one or information sources;
select one or more parts of a map; and
process the measurement data with a state estimation algorithm within the confines of the selected one or more parts in order to determine an estimated state of a mobile apparatus.

2. The processing apparatus of claim 1, wherein the one or more information sources comprise sensors, which are communicatively coupled with a mobile apparatus.

3. The processing apparatus of claim 1, wherein the state estimation algorithm comprises a particle filter based algorithm.

4. The processing apparatus of claim 1, wherein the one or more parts are selected based on a history of one or more previous events associated with a mobile apparatus.

5. The processing apparatus of claim 1, wherein the one or more parts are selected based on a history of one or more past locations of a mobile apparatus.

6. The processing apparatus of claim 1, wherein the one or more parts are selected based on network data associated with a mobile apparatus.

7. The processing apparatus of claim 1, wherein the one or more parts are selected based on surveillance data associated with a mobile apparatus.

8. The processing apparatus of claim 1, wherein the one or more parts are selected based on the measurement data.

9. The processing apparatus of claim 1, wherein the map is divided into the parts so that the parts are side by side adjacent.

10. The processing apparatus of claim 1, wherein the map is divided into the parts so that the parts are at least partly overlapping.

11. The processing apparatus of claim 1, wherein the map is divided into the parts so that the parts are of a regular shape.

12. The processing apparatus of claim 1, wherein the map is divided into the parts so that the parts are of a polygon shape.

13. The processing apparatus of claim 1, wherein the map is divided into the parts so that the parts are of a square shape.

14. The processing apparatus of claim 1, wherein the map is divided into the parts so that the parts are such that their sides are defined geographically along the longitudes and the latitudes of the Earth.

15. The processing apparatus of claim 1, wherein the map is divided into the parts so that a size of the part and/or a location of the part is selected dynamically.

16. The processing apparatus of claim 1, wherein the map is divided into the parts so that the map comprises parts of different size.

17. The processing apparatus of claim 1, wherein the map is a global map.

18. The processing apparatus of claim 1, wherein the map is fixed to a co-ordinate system.

19. The processing apparatus of claim 1, wherein the map covers indoor locations comprising buildings, subways, train stations, airports, harbors, mines and other man-made structures above ground or underground, and possibly also outdoor locations adjacent to the indoor locations.

20. The processing apparatus of claim 1, wherein the map comprises a plurality of locations, and each location is associated with one or more previously measured and stored values, which are comparable with the measurement data.

21. The processing apparatus of claim 20, wherein a grid of the values is specific to a type of the information source, which results in that a part of the map comprises the values in different grids of different information sources.

22. The processing apparatus of claim 1, wherein a part of the map is empty.

23. The processing apparatus of claim 1, wherein an empty part connects two non-empty parts of the map.

24. The processing apparatus of claim 23, wherein the empty part is located at least partly outdoors and it connects two non-empty parts that are located at least partly indoors.

25. The processing apparatus of claim 1, wherein the measurement data is processed with the state estimation algorithm utilizing a particle filter, wherein weights of the particle filter are modified at least partly based on one or more of the following: an uncertainty of the map related to a specific particle, an empty part of the map related to a specific particle.

26. The processing apparatus of claim 1, wherein the selection of the one or more parts of the map is performed anew so that new parts of the map are selected based on a prediction of a future state of the mobile apparatus, which is based on the estimated state of the mobile apparatus.

27. The processing apparatus of claim 1, wherein the measurement data comprises at least one of the following types of the measurement data: inertial sensor data, magnetometer data, indoor base station data, cellular network data, wireless access point data, WiFi data, Bluetooth radio data, air pressure data, illumination data, audio data, video data, camera data, temperature data, barometer data, altitude data, range sensor data, indoor positioning data, global navigation satellite system data, smell sensor data, air quality sensor data, radar data, data generated by an internal sensor of the mobile apparatus, data generated by a sensor external to the mobile apparatus.

28. The processing apparatus of claim 27, wherein the measurement data is processed with the state estimation algorithm utilizing a particle filter, and wherein a first round of the processing with the particle filter is performed with one or more types of the measurement data, and a second and subsequent rounds of the processing with the particle filter are performed with more types of the measurement data and/or with different types of the measurement data than in the previous round.

29. The processing apparatus of claim 1, wherein the estimated state of the mobile apparatus comprises one or more of the following: a location of the mobile apparatus, a speed of the mobile apparatus, a heading of the mobile apparatus, an alignment of the mobile apparatus.

30. A non-transitory computer-readable storage medium comprising computer program code which, when loaded into a processing apparatus and executed by the processing apparatus causes the processing apparatus at least to:
obtain measurement data generated by one or more information sources;
select one or more parts of a map; and
process the measurement data with a state estimation algorithm within the confines of the selected one or more parts in order to determine an estimated state of a mobile apparatus.

31. A method in a processing apparatus, comprising:
obtaining measurement data generated by one or more information sources;
selecting one or more parts of a map; and
processing the measurement data with a state estimation algorithm within the confines of the selected one or more parts in order to determine an estimated state of a mobile apparatus.
